(19) United States
(12) Patent Application Publication
(10) Pub. No.: US 2022/0307539 A1
(43) Pub. Date: Sep. 29, 2022

(54) APPARATUS FOR ASSEMBLING SCREWS

(71) Applicant: Fulian Precision Electronics (Tianjin) Co., LTD., Tianjin (CN)

(72) Inventors: YI-PEI HSIAO, New Taipei (TW); TUNG-HO SHIH, New Taipei (TW)

(21) Appl. No.: 17/535,939

(22) Filed: Nov. 26, 2021

(30) Foreign Application Priority Data
Mar. 24, 2021 (CN) 202110313219.7

(51) Int. Cl. F16B 35/06

(52) U.S. Cl. CPC F16B 35/06; F16B 2200/509

(57) ABSTRACT

An apparatus for assembling screws, the apparatus includes a rack and a holder. The holder is arranged on the rack. The holder includes a convex and an opening. The opening is communicated with the convex, the screw is capable of moving in the opening and latched to and fasten to the convex.

### CROSS-REFERENCE TO RELATED APPLICATIONS

This application claims priority to Chinese Patent Application No. 202110313219.7 filed on Mar. 24, 2021 in China National Intellectual Property Administration, the contents of which are incorporated by reference herein.

### FIELD

The subject matter herein generally relates to server manufacture, and particularly to an apparatus for assembling screws.

### BACKGROUND

When assembling a cabinet of a server, to ensure a strength of the cabinet, some screws are needed to be assembled to the cabinet. To assemble a large cabinet, a great number of screws are needed to be assembled to the cabinet. Middle sections or deep interior of the cabinet are difficult to reach, and screws extending from the interior of the cabinet to the outside may rotate with the corresponding nuts when the operator tried to tighten the screws, which is not an effective process. Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram of at least one embodiment of an apparatus for assembling screws inserting into a cabinet according to the present disclosure.

FIG. 2 is a schematic diagram of at least one embodiment of the screw separated from the apparatus according to the present disclosure.

FIG. 3 is a schematic diagram of a second embodiment of a screw latching to the apparatus according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The present disclosure is described in relation to an apparatus and a wireless communication device using the same.

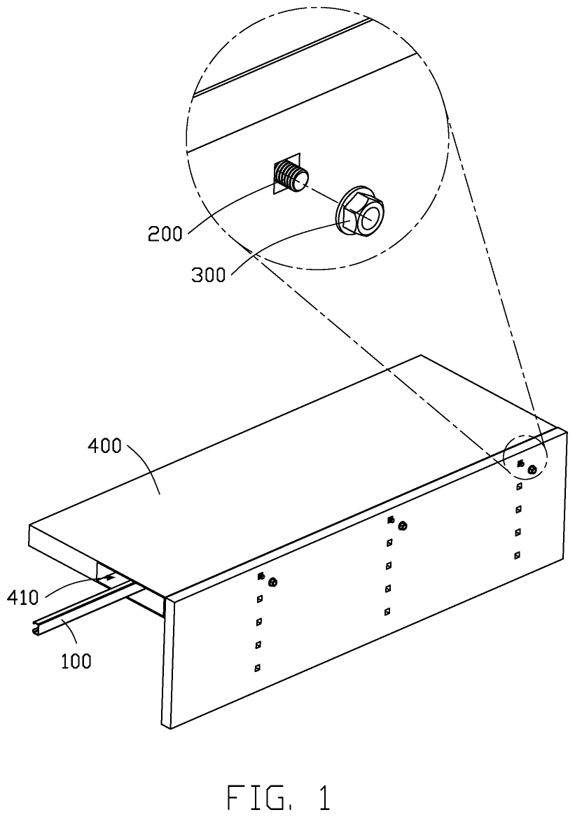

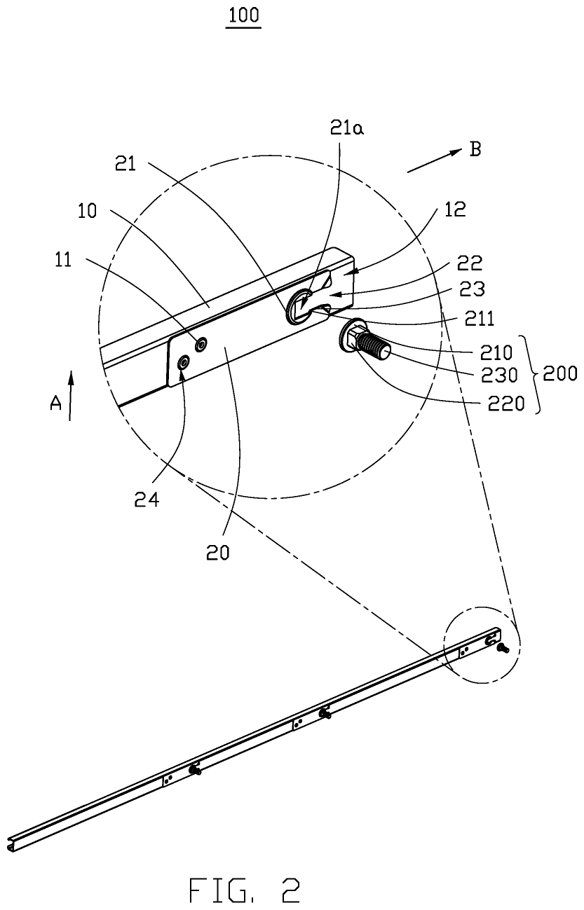

FIGS. 1 and 2 illustrate at least one embodiment of an apparatus 100 for assembling screws 200. The apparatus 100 includes a rack 10 and a holder 20. The holder 20 is arranged on the rack 10. The holder 20 includes a convex 21 and defines an opening 22. The opening 22 is communicating with the convex 21. The screw 200 may move along the opening 22 and be latched into the convex 21. The rack 10 may be inserted into a cabinet 400 for assisting a positioning and assembling of the screw 200 to the cabinet 400.

In at least one embodiment, when the cabinet 400 in use, the screw 200 may secure other components to the cabinet 400. When the screw 200 is needed to be inserted into the cabinet 400 and placed in portions which are difficult to access, such as a groove 410, the assembling operator finds it difficult to manually assemble the screw 200. At this time, the apparatus 100 will assist in assembling the screw 200 to the cabinet 400.

For using specific screw 200 on specific cabinet 400, the screw 200 may include a screw head 210, a latch portion 220, and a thread portion 230 connected in that order. The screw head 210 may be inserted into the convex 21, the thread portion 230 may extended out of the cabinet 400 and connected to a threaded nut outside the cabinet 400, and the latch portion 220 may be latched to the convex 21 to prevent the screw 200 and the nut rotating at the same time when securing the nut to the screw 200.

In at least one embodiment, the rack 10 may be rod-shaped and capable of reaching into narrow gaps in the cabinet 400.

In at least one embodiment, the screw head 210 may be flat with a circular head. In other embodiments, the screw head 210 may also be a semi-circular or oval.

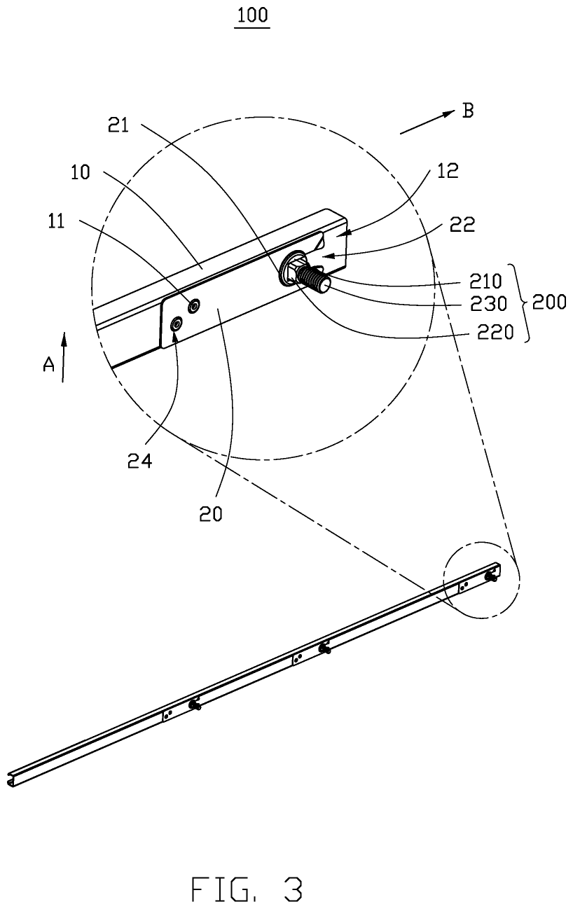

Referring to FIGS. 2 and 3, to prevent the screw 200 and the nut rotating at the same time, the convex 21 includes a latch room 21a communicating with the opening 22. The screw head 210 may be inserted into the latch room 21a, the latch portion 220 may extend out of the latch room 21a, an external wall of the latch portion 220 resisting an internal wall of the convex 21, so the nut rotating on the thread portion 230 will drive the whole screw 200 to rotate. The thread portion 230 drives the latch portion 220, thus the latch portion 220 resists the internal wall of the convex 21, so the screw 200 and the convex 21 are immobile while the nut rotates relative to the screw 200, thereby securing the screw 200 to the nut.

In at least one embodiment, the latch room 21a may be a columnar chamber, a size and a shape of the latch room 21a may be same as or fitted to a size and a shape of the screw head 210.

To separate the apparatus 100 from the screw 200 and from the cabinet 400 when securing the screw 200 to the nut 300, the convex 21 includes a rounded corner 211 contacting the holder 20. After the apparatus 100 positions the screw 200 within the cabinet 400, externally separating the apparatus 100 to contact an external wall of the screw head 210 to the rounded corner 211. During continuous forces, the screw head 210 presses the rounded corner 211 and uplifts the holder 20 for a predetermined distance, thus the apparatus 100 may be extracted from within such distance.

To prevent the screw 200 separating from the apparatus 100 through the opening 22 when the apparatus 100 is placed within the groove 410 of the cabinet 400, along a first direction A, a width of the opening 22 is smaller than a diameter of the convex 21, the first direction A is perpendicular to the opening 22. When the apparatus 100 is inside the groove 410 of the cabinet 400, due to the width of the opening 22 being smaller than the diameter of the convex 21, the screw head 210 contacts an internal wall of a contact position of the opening 22 and the latch room 21a, thus some force is needed to separate the screw 200 from the apparatus 100, so as to prevent the screw 200 separating from the apparatus 100 and falling into the cabinet 400 when the apparatus 100 is manipulated into the groove 410 of the cabinet 400.

For the screw 200 inserted into the opening 22 and moving in the opening 22 to latch to the latch room 21a, the holder 20 includes two edgefolds 23. The two edgefolds 23 are symmetrically arranged on the holder 20 relative to a central line of a second direction B of the opening 22, the second direction B may be a defining direction of the opening 22. When the screw 200 latches to the latch room 21a, the screw head 210 resists against the two edgefolds 23, the screw head 210 applies force to uplift the two edgefolds 23, thereby forming a space between the two edgefolds 23 and the rack 10. The screw head 210 may be inserted into the opening 22 through the space and capable of moving in the opening 22 to latch to the latch room 21a of the convex 21.

Furthermore, a movable space (not shown) is formed between the two edgefolds 23 and the rack 10, the screw 200 may resist within the movable space and be capable of moving in the opening 22. In at least one embodiment, the two edgefolds 23 are arranged along a direction away from the rack 10, the movable space is communicating with the opening 22, thus the screw 200 may move to the opening 22 through the movable space.

In at least one embodiment, the holder 20 may be but is not limited to being an elastically deformable structure, such as a piece of elastic stainless steel.

For securing the holder 20 to the rack 10, the holder 20 defines a mounting hole 24, the rack 10 includes a mounting post 11. The mounting post 11 may be inserted into and secured to the mounting hole 24, thus the holder 20 is secured to the rack 10. In at least one embodiment, the mounting hole 24 may be circular, the mounting post 11 may be a column having a similar diameter to that of the mounting hole 24, thus the mounting post 11 may be inserted into and secured to the mounting hole 24 and the holder 20 is prevented from separating from the rack 10. The structures of the mounting hole 24 and the mounting post 11 may be other structures, for instance, in other embodiments, the mounting hole 24 may be oval, the mounting post 11 may be an oval post adapted to the mounting hole 24.

For improving an assembling efficiency of the screw 200, in at least one embodiment, there are a plurality of the holders 20 randomly arranged on the rack 10, when the screw 200 is latched to the latch room 21a, the rack 10 able to offer a plurality of screws 200 to predetermined screw-hole positions of the cabinet 400. The positions of the holders 20 may be arranged according to positions of screws 200 to be assembled.

For preventing interference of the holder 20 and the cabinet 400 when the rack 10 is inserted into the groove 410 of the cabinet 400, the rack 10 includes a side wall 12, the holders 20 are secured on the side wall 12, a width of the holder 20 being smaller than or equal to a width of the side wall 12. While the rack 10 is being inserted into the groove 410 of the cabinet 400, the width of the holder 20 being smaller than or equal to the of the side wall 12 means that the holder 20 will entirely fit to the side wall 12 but not extend out of the rack 10, to avoid any parts of the holder 20 which extend from the side wall 12 reaching the cabinet 400 when the rack 10 is being inserted into the groove 410, thereby preventing any interference to the holder 20 and the cabinet 400.

A screw-fitting operation in at least one embodiment may include: firstly, forming a plurality of mounting posts 11 on the rack 10 according to positions needed to be mounted with screws 200 in the cabinet 400, and securing the mounting posts 11 to the mounting holes 24 of the holders 20, thus securing the holders 20 to the rack 10.

Secondly, abutting the screw head 210 to the two edgefolds 23, and forcing the screw head 210 to uplift the two edgefolds 23 and enter the opening 22. The screw head 210 moves in the opening 22 until latching to the latch room 21a, at this time, the holder 20 restores and the screw head 210 is latched to the latch room 21a. The operation is repeated until all the screws 200 are latched to the latch rooms 21a of the convex 21.

Finally, the rack 10 is inserted into the groove 410 of the cabinet 400 and moved to predetermined positions, and the thread portion 230 is extended out of the cabinet 400, thus the nut 300 may be preliminarily engaged with the screw 200 and remain a space for at least two screw buds. At this time, extracting the rack 10, the screw head 210 resists the rounded corner 211 and uplifts the holder 20, the screw head 210 inserts into the opening 22 through a space formed by the uplifting of the holder 20 and separates from the holder 20 along the opening 22. The screw 200 and the nut 300 are then tightened to secure the screw 200.

The apparatus 100 for assembling screw secures the holder 20 on the rack 10, the holder 20 include a convex 21 and an opening 22 communicating with the convex 21, the screw 200 may move in the opening 22 and latch to the convex 21. The rack 10 may be manipulated into the cabinet 400 for assisting in assembling the screw 200 to the cabinet 400.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An apparatus for assembling screws comprising:
a rack; and
at least one holder arranged on the rack;
wherein the at least one holder comprises a convex and an opening communicated with the convex, the opening is configured to receive a screw, and the convex is shaped to latch the screw in the opening.

2. The apparatus of claim 1, wherein the convex comprises a latch room communicated with the opening, the latch room is configured to latch the screw.

3. The apparatus of claim 2, wherein a contacting position of the convex and the at least one holder is a rounded corner, the rounded corner is configured to receive the screw and convey the screw to the latch room via the opening.

4. The apparatus of claim 1, wherein along a first direction, a width of the opening is smaller than a diameter of the convex, the first direction is perpendicular to a defining direction of the opening.

5. The apparatus of claim 4, wherein the holder comprises two edgefolds, along a second direction, the two edgefolds are symmetrically arranged on the at least one holder relative to an imaginary central line of the opening, the second direction is the defining direction of the opening.

6. The apparatus of claim 5, wherein the two edgefolds and the rack form a movable space therebetween, the movable space is configured to confine the screw to move into the opening.

7. The apparatus of claim 6, wherein the two edgefolds is arranged along a direction away from the rack, the movable space communicates with the opening.

8. The apparatus of claim 1, wherein the holder defines a mounting hole, the rack comprises a mounting post, the mounting post is inserted into and secured to the mounting hole, thus the at least one holder is secured to the rack.

9. The apparatus of claim 1, wherein the apparatus comprises a plurality of holders randomly arranged on the rack.

10. The apparatus of claim 9, wherein the rack comprises a side wall, the plurality of holders are arranged on the side wall, a width of each of the plurality of holders is smaller than or equal to a width of the side wall.
